(19) United States
(12) Patent Application Publication
(10) Pub. No.: US 2023/0097261 A1
(43) Pub. Date: Mar. 30, 2023

(54) PIVOT CRADLE BEARING SYSTEM AND METHOD FOR PRODUCING A SYNCHRONISATION DEVICE OF A PIVOT CRADLE BEARING SYSTEM

(71) Applicant: Schaeffler Technologies AG & Co. KG, Herzogenaurach (DE)

(72) Inventor: Vasyl Kramar, Grettstadt (DE)

(73) Assignee: Schaeffler Technologies AG & Co. KG, Herzogenaurach (DE)

(21) Appl. No.: 17/910,846

(22) PCT Filed: Jan. 18, 2021
(86) PCT No.: PCT/DE2021/100052

§ 371 Date: Sep. 12, 2022

(30) Foreign Application Priority Data
Mar. 13, 2020 (DE) 10 2020 106 907.3

(51) Int. Cl. F16C 19/46; F16C 19/50; F16C 33/30

(52) U.S. Cl. CPC F16C 19/46; F16C 19/502; F16C 33/306

(57) ABSTRACT

A pivot cradle bearing system includes a curved cage segment in which rolling elements are guided, which are arranged between two bearing parts which can be pivoted relative to each other. A synchronization device, which is designed for the synchronization of the relative movement of the bearing parts with the displacement of the cage segment, comprises a pivot arm, which is mounted in the cage segment. A ball-and-socket joint, by means of which a snap-action connection is formed, is provided to support the pivot arm in the cage segment.

### CROSS-REFERENCE TO RELATED APPLICATIONS

This application is the U.S. National Phase of PCT Appln. No. PCT/DE2021/100052 filed Jan. 18, 2021, which claims priority to DE 10 2020 106 907.3 filed Mar. 13, 2020, the entire disclosures of which are incorporated by reference herein.

### TECHNICAL FIELD

The disclosure relates to a pivot cradle bearing system suitable for use in an axial piston machine. The disclosure further relates to a method for producing a synchronization device of a pivot cradle bearing system, wherein movements of a cage segment of a pivot cradle bearing system guiding rolling elements, in particular cylindrical rollers, are synchronized with the pivot movements of a pivot cradle by means of the synchronization device.

### BACKGROUND

A pivot cradle bearing system of the type in question for a hydraulic axial piston machine is known, for example, from DE 25 21 312 B1. With the aid of the known pivot cradle bearing system, a swash plate, i.e., a pivot cradle, can be mounted in a housing in a variable angular position. By adjusting the angular position of the swash plate, the stroke of pistons of the axial piston machine changes. The known swash plate pivot bearing comprises rollers as rolling bodies which are guided in a cage. A rod extending approximately radially to the curvature of the arcuate cage is pivotably articulated on the cage, the rod in the case of DE 25 21 312 B1 additionally being radially displaceable with respect to the cage. The rod is pivotably mounted with its one end in a stationary manner at one point on the housing and is arranged with its other end so as to be pivotable on the swash plate and displaceable in its longitudinal direction. Each pivoting of the swash plate is thus associated with a displacement of the cage, which overall provides a synchronization device.

A further axial piston machine with a pivot bearing is described in DE 10 2006 023 711 A1. In this case, a cage segment is guided by an angular guide element which is rotatably and displaceably mounted on the cage segment and has two guide legs which are attached in different ways to the parts which can be pivoted relative to one another.

DE 34 42 391 C1 discloses another tracking device for a cage of a segment rolling bearing of a cradle, i.e., a pivot cradle bearing system. The tracking device comprises two guide grooves, one guide member being guided in a point of intersection of the guide grooves.

Swash plate pivot bearings with shifting links for synchronizing the cage movement with the pivot movement of a bearing part are also described in DE 10 2006 023 711 A1, DE 10 2009 013 094 B4, DE 10 2012 202 742 B3 and DE 10 2017 126 525 A1.

Various design options for cages of pivot cradle bearing systems can be found in documents DE 87 05 446 U1, DE 10 2005 034 739 A1 and DE 10 2014 206 803 B3.

DE 10 2017 126 525 A1 describes a pivot cradle bearing system in which the movement of a cage is delimited by stops.

Complete axial piston machines including a pivot cradle bearing system are described, for example, in documents DE 199 60 941 A1 and DE 10 2013 210 070 B3.

DE 10 2019 108 657 A1 discloses a rolling bearing arrangement in which a pivot arm is fixed to the cage by means of a pivot arm guide, wherein the pivot arm guide is fixed to the cage by means of a snap-lock connection.

### SUMMARY

The disclosure is based on the object of further developing a pivot cradle bearing system with a synchronized cage compared with the cited prior art, in particular with regard to aspects of manufacture.

According to the disclosure, this object is achieved by a pivot cradle bearing system having the features described herein. The object is also achieved by a method for producing a synchronization device according to the present disclosure. The embodiments and advantages of the disclosure explained below in connection with the production method also apply, mutatis mutandis, to the device, i.e., the pivot cradle bearing system, and vice versa.

The pivot cradle bearing system comprises, in a basic concept known per se, a curved cage segment in which rolling bodies, in particular cylindrical rollers, are guided, which roll between two bearing parts which can be pivoted relative to one another, wherein a synchronization device, which is designed for the synchronization of the relative movement of the bearing parts with the displacement of the cage segment comprises a pivot arm, which is mounted in the cage segment. According to the disclosure, a ball-and-socket joint is provided for mounting the pivot arm in the cage segment, by means of which a snap-action connection is formed.

Due to the elimination of additional means for holding the pivot arm in the cage segment, the synchronization device can be mounted particularly efficiently. It has been shown that even in the case of pivot cradle bearing systems in axial piston machines, in which very high forces act, a permanently stable bearing arrangement of the pivot arm in the cage segment is provided in this way.

In a preferred embodiment, the outer sliding bearing piece of the ball-and-socket joint that also forms a snap-action connection is provided directly by the cage segment, wherein a spring arrangement is formed by the outer sliding bearing piece. This spring arrangement preferably comprises multiple spring tongues generally arranged in an annular manner and provided for contacting the pivot arm, each of which is separated from the other by a groove. The entire spring arrangement is formed integrally with a bearing plate, which is formed by the cage segment and in which the ball-and-socket joint is located.

According to a first possible variant, the spring tongues are surrounded by a single annular groove formed in the bearing plate, wherein the spring tongues do not project beyond the bearing plate. According to an alternative variant, the spring tongues are designed as elevations protruding from the bearing plate, i.e. projecting beyond the bearing plate. In this case, in contrast to the first variant, there are preferably no resilient structures formed within the bearing plate. In both cases, the bearing plate is an integral part of the cage segment, wherein the outer part of the ball-and-socket joint is formed by the bearing plate.

The number of spring tongues is not subject to any theoretical restrictions. For example, the spring arrangement is formed by three, four or six spring tongues which—if the grooves kept free between the spring tongues are disregarded—extend in a generally annular arrangement over an angle of approximately 120 degrees, 90 degrees and 60 degrees respectively.

In a preferred embodiment, the spring tongues, which are formed directly from the material of the cage segment, are directed radially outwards with respect to the pivot axis of the pivot cradle bearing system. Each spring tongue is curved to match the spherical shape of the inner sliding bearing piece, resulting in a spherical overlap when the snap-action connection is assembled. The spring tongues are preferably directly adjacent to an uninterrupted sliding surface of the outer sliding bearing piece.

Irrespective of whether the spring tongues are aligned radially outwards or radially inwards, i.e. in the direction of the pivot axis of the pivot cradle bearing system, the spring tongues can be arranged within the cross section of the bearing plate in a particularly space-saving manner in accordance with the first variant already explained. This means that each individual spring tongue extends in the radial direction over only part of the thickness of the bearing plate. The aforementioned sliding surface of the outer sliding bearing piece extends over the remaining part of the thickness of the bearing plate. When the spring arrangement is designed according to the second variant, on the other hand, the entire thickness of the bearing plate is available for forming the sliding surface of the outer sliding bearing piece.

The cage segment including the bearing plate is preferably made of plastic. In contrast, the pivot arm including the inner sliding bearing piece of the ball-and-socket joint is preferably made of metal.

The synchronization device of the pivot cradle bearing can be produced in the following steps:
providing a cage segment for guiding rolling elements, in particular cylindrical rollers, which has a bearing plate through which an outer sliding bearing piece is formed,
providing a preferably integral pivot arm made of metal, which has a spherical thickening spaced apart from its ends as a sliding bearing inner piece, wherein the diameter of the sliding bearing inner piece is greater than the minimum inner diameter of the sliding bearing outer piece,
inserting the pivot arm into the cage segment, wherein the outer sliding bearing piece is elastically expanded and the inner sliding bearing piece snaps into the outer sliding bearing piece, i.e. a snap-action connection is established between the cage segment and the pivot arm.

Depending in particular on the geometric design of the outer sliding bearing piece, the pivot arm can be inserted into the cage segment either from the inside to the outside or from the outside to the inside. In a preferred embodiment, the pivot arm is inserted from the outside to the inside, wherein the displacement of the pivot arm radially inwards that occurs in this process relates to the pivot axis of the pivot cradle bearing system.

The snap-action connection between the cage segment and the pivot arm is preferably designed in such a way that the synchronization device can not only be mounted easily, using moderate forces, but also be dismantled non-destructively if required. In the intended operation of an axial piston machine comprising the pivot cradle bearing system, the ball-and-socket joint designed as a snap-action connection is characterized by a high radial load capacity and at the same time a sufficiently high load capacity in both axial directions, relative to the longitudinal axis of the pivot arm.

### BRIEF DESCRIPTION OF THE DRAWINGS

Below, two exemplary embodiments of the disclosure are explained in more detail by means of a drawing. In the figures:

FIG. 1 shows components of a first exemplary embodiment of a pivot cradle bearing system in an exploded view,

FIG. 2 shows a synchronization device of the pivot cradle bearing system according to FIG. 1 in a sectional view,

FIG. 3 shows a detail of the arrangement according to FIG. 2,

FIG. 4 shows a cage segment of a second exemplary embodiment of a pivot cradle bearing system,

FIG. 5 shows a detail of the pivot cradle bearing system comprising the cage segment according to FIG. 4.

### DETAILED DESCRIPTION

Unless otherwise stated, the following explanations relate to both exemplary embodiments. Parts that correspond to each other or have basically the same effect are marked with the same reference symbols in all figures.

A pivot cradle bearing system 1, only part of which is shown, comprises a curved cage segment 2 made of plastic, in which rolling bodies not shown, namely cylindrical rollers, are guided in cage pockets 3. In the fully assembled state of the pivot cradle bearing system 1, the rolling bodies contact a pivot cradle and a housing as bearing parts that can be pivoted relative to one another. The pivot cradle bearing system 1 is part of an axial piston machine not shown further, i.e., an axial piston pump or an axial piston motor. The volume flow through the axial piston machine can be influenced with the aid of the pivot cradle bearing system 1. With regard to the basic structure and function of the pivot cradle bearing system 1, reference is made to the prior art cited at the outset.

The pivot cradle bearing system 1 includes a synchronization device, denoted 4 as a whole, which ensures that the pivoting of the cage segment 2 is coordinated with the relative movement between the bearing parts which can be adjusted with respect to one another. The synchronization device 4 comprises a pivot arm 5, which is mounted in the cage segment 2. Here, the pivot arm 5 and the cage segment 2 form a sliding bearing, namely a ball-and-socket joint 6. The ball-and-socket joint 6 is formed by an inner sliding bearing piece 8, which is provided directly by the pivot arm 5, and an outer sliding bearing piece 7, which is provided by a bearing plate 9 of the cage segment 2. The bearing plate 9 is slightly curved in accordance with the curvature of the cage segment 2 and merges into a cage strip 10. The cage strip 10 is connected to a further cage strip 11 via webs 12, wherein a cage pocket 3 is formed between two webs 12 that are adjacent in a circumferential direction. The webs 12 are oriented in parallel with the pivot axis of the pivot cradle bearing system 1. Overall, the cage segment 2 is therefore an integral plastic part.

The inner sliding bearing piece 8 formed by the pivot arm 5 is also referred to as a joint ball. Furthermore, the pivot arm 5 has an end ball 13, 14 at each of its two ends. The joint ball 13 arranged radially inside the cage segment 2, i.e., the end ball 13 that is spaced apart from the pivot axis of the pivot cradle bearing system 1 less than the cage segment 2, has a smaller distance from the joint ball 8 than the outer end ball 14. This is tantamount to an outer arm 15 of the pivot arm 5 being longer than an inner arm 16. The length of the arms 15, 16 is measured in each case starting from the center of the ball-and-socket joint 6, i.e. from the center of the spherical inner sliding bearing piece 8.

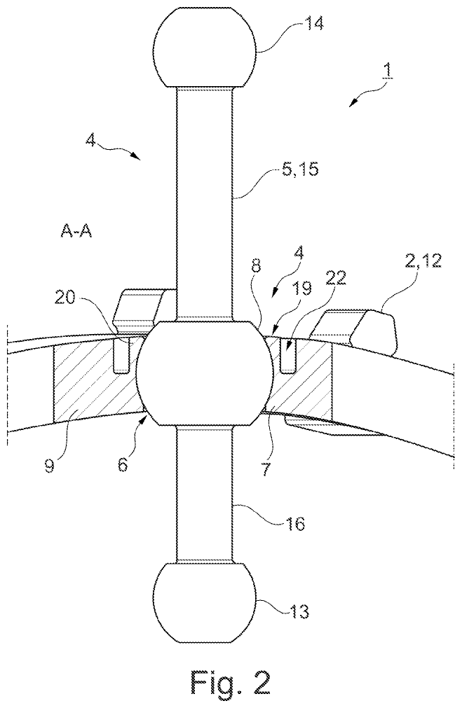

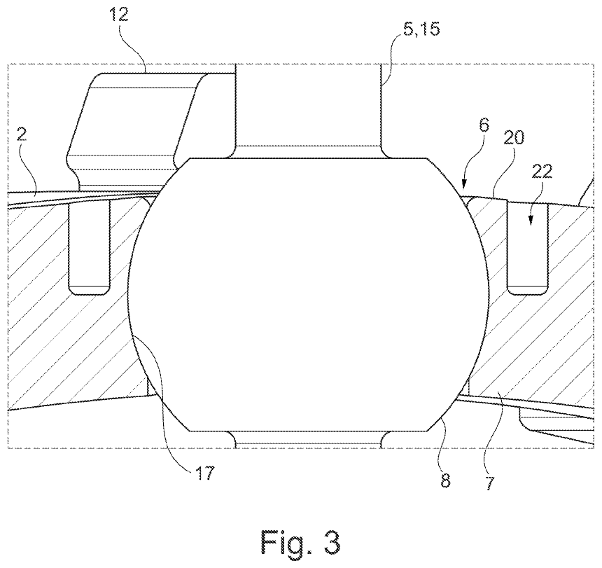

The inner sliding bearing piece 8 is designed to be symmetrical to an imaginary plane in which the center of the inner sliding bearing piece 8 lies and to which the longitudinal axis of the pivot arm 5—with respect to its arrangement according to FIG. 2—represents a surface normal. In contrast, the outer sliding bearing piece 7 is designed to be asymmetrical to the plane through the ball-and-socket joint 6: An inner portion 17 of the outer sliding bearing piece 7 provides an uninterrupted sliding surface. A spring arrangement 18, which provides a segmented sliding surface, adjoins the inner portion 17 radially outwardly—with respect to the pivot axis of the pivot cradle bearing system 1.

The spring arrangement 18 is part of a snap-action connection, denoted 19 as a whole, which is established between the cage segment 2 and the pivot arm 2. As an integral part of the bearing plate 9 and thus of the entire cage segment 2, the spring arrangement 18 in both exemplary embodiments comprises four spring tongues 20 which, starting from the inner portion 17, extend radially outwards. The spring tongues 20 together describe an annular shape, wherein a groove 21 is visible between each two spring tongues 20.

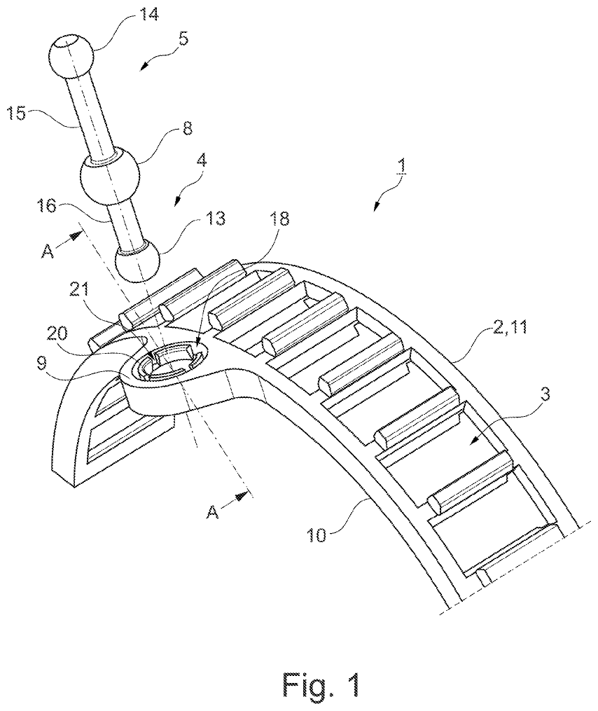

In the exemplary embodiment according to FIG. 1, the annular spring arrangement 18 is surrounded by an annular groove 22, which allows deflection of the individual spring tongues 20 during assembly. In this case, the complete spring arrangement 18 is arranged between the inner and outer surfaces of the bearing plate 9, each curved in accordance with the cage segment 2.

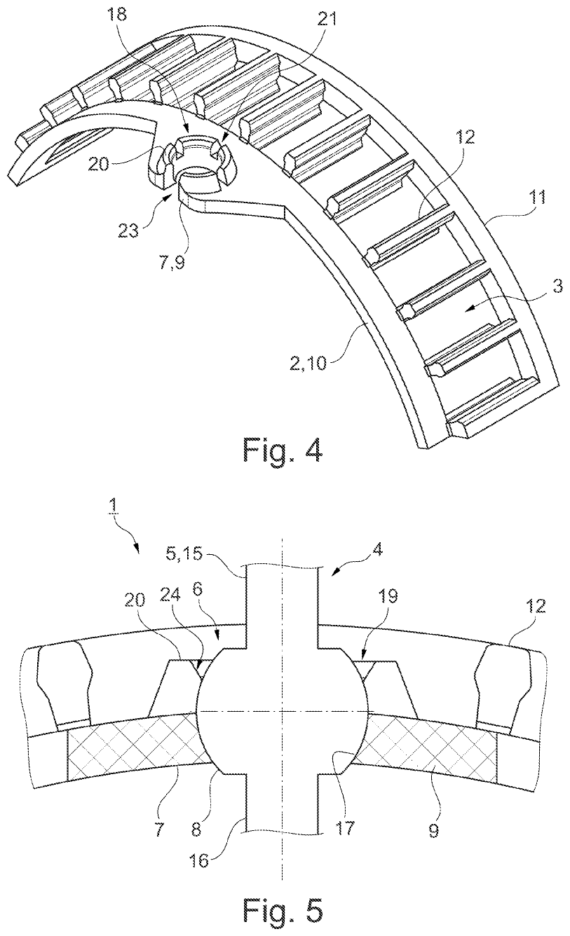

In contrast to this, the spring tongues 20 in the exemplary embodiment according to FIG. 4 project beyond the bearing plate 9. In this case, the inner portion 17 of the outer sliding bearing piece 7 formed by the bearing plate 9 is interrupted by a gap 23, so that the outer sliding bearing piece 7 describes an open annular shape, that is, a C-shape. In this case, there is no annular groove on the spring arrangement 18. Insertion chamfers on the individual spring tongues 20 present in the design according to FIG. 1 are also denoted by 24.

In both exemplary embodiments, the pivot arm 5, which is aligned radially—with respect to the pivot axis of the pivot cradle bearing system 1—is snapped into the outer sliding bearing piece 7 from the outside. Conversely, if necessary, non-destructive disassembly of the synchronization device 4 is possible by pulling out the pivot arm 5 to the outside. The two end balls 13, 14 have a smaller diameter than the joint ball 8 and thus do not hinder the assembly or disassembly of the metal pivot arm 5.

### LIST OF REFERENCE NUMERALS

1 pivot cradle bearing system
2 cage segment
3 cage pocket
4 synchronization device
5 pivot arm
6 ball-and-socket joint
7 outer sliding bearing piece
8 inner sliding bearing piece, joint ball
9 bearing plate
10 cage strip
11 cage strip
12 web
13 inner end ball
14 outer end ball
15 outer arm
16 inner arm
17 inner portion of outer sliding bearing piece
18 spring arrangement
19 snap-action connection
20 spring tongue
21 groove
22 annular groove

1. A pivot cradle bearing system comprising: a curved cage segment, in which rolling elements are guided, which are arranged between two bearing parts which can be pivoted relative to one another, wherein a synchronization device, which is designed for the synchronization of a relative movement of the bearing parts with the displacement of the cage segment, comprises a pivot arm, which is mounted in the cage segment, wherein a ball-and-socket joint, by means of which a snap-action connection is formed, is provided to support the pivot arm in the cage segment.

2. The pivot cradle bearing system according to claim 1, wherein an outer sliding bearing piece of the ball-and-socket joint is formed directly by the cage segment.

3. The pivot cradle bearing system according to claim 2, wherein a spring arrangement is formed by the outer sliding bearing piece.

4. The pivot cradle bearing system according to claim 3, wherein the spring arrangement comprises a plurality of spring tongues arranged in an annular manner, each of which is separated from one another by a groove and is formed integrally with a bearing plate, which is formed by the cage segment and in which the ball-and-socket joint is disposed.

5. The pivot cradle bearing system according to claim 4, wherein the spring tongues are surrounded by a single annular groove and do not project beyond the bearing plate.

6. The pivot cradle bearing system according to claim 4, wherein the spring tongues are designed as elevations projecting beyond the bearing plate.

7. The pivot cradle bearing system according to claim 5, wherein the spring tongues are directed radially outwards with respect to a pivot axis of the pivot cradle bearing system.

8. The pivot cradle bearing system according to claim 1, wherein the cage segment is made of plastic and the pivot arm, including an inner sliding bearing piece of the ball-and-socket joint is made of metal.

9. A method for producing a synchronization device of a pivot cradle bearing system, comprising the following steps:
providing a cage segment provided for guiding rolling elements, which has a bearing plate through which an outer sliding bearing piece is formed,
providing a pivot arm which has a spherical thickened portion spaced apart from ends thereof as an inner sliding bearing piece, wherein a diameter of the inner sliding bearing piece is greater than a minimum inner diameter of the outer sliding bearing piece,
inserting the pivot arm into the cage segment, wherein the outer sliding bearing piece is elastically expanded and the inner sliding bearing piece snaps into the outer sliding bearing piece.

10. The method according to claim 9, further comprising snapping the pivot arm into a ball-and-socket joint from an outside, relative to a pivot axis of the pivot cradle bearing system.
